(19) United States
(12) Patent Application Publication
(10) Pub. No.: US 2011/0193493 A1
(43) Pub. Date: Aug. 11, 2011

(54) LIGHT EMITTING DIODE LIGHTING APPARATUS

(75) Inventor: Tzu-Hao Chao, Taipei (TW)

(73) Assignee: EVERLIGHT ELECTRONICS CO., LTD., Taipei (TW)

(21) Appl. No.: 13/023,542

(22) Filed: Feb. 9, 2011

(30) Foreign Application Priority Data
Feb. 9, 2010 (TW) 99103958

(51) Int. Cl. H05B 37/02

(52) U.S. Cl. 315/294

(57) ABSTRACT

A light emitting diode (LED) lighting apparatus is provided. The LED lighting apparatus includes a first LED unit and a rectification circuit. The rectification circuit includes a second LED unit. The first LED unit is disposed on a direct current (DC) path. The first LED unit can be used to emit a first light. The rectification circuit is coupled to an alternating current (AC) power source and the first LED unit. The rectification circuit can be used to provide a DC power signal to the DC path. The second LED unit is disposed on a first AC path and coupled between the AC power source and the DC path. The second LED unit can be used to emit a second light to mix the first light for generating a third light.

### CROSS-REFERENCE TO RELATED APPLICATION

This application claims the priority benefit of Taiwan application serial no. 99103958, filed on Feb. 9, 2010. The entirety of the above-mentioned patent application is hereby incorporated by reference herein and made a part of this specification.

### BACKGROUND OF THE INVENTION

1. Field of the Invention

The invention generally relates to a light emitting diode (LED) lighting apparatus, and more particularly, to an LED lighting apparatus having a high color rendering property and a high efficiency property.

2. Description of Related Art

With the rapid development of optoelectronic technologies, the LED light source now play a significant role in the optoelectronic industry, as it is widely applied in various fields. Nowadays, electric power is typically used as an alternating current (AC) power. Since a voltage characteristic of the AC power varies alternately with time, when the LED is used for lighting, AC power is difficult to adopt for the LED.

Taiwan Patent No. 1302039 proposes an LED chip structure having an AC loop. The LED chip structure includes a set of AC LED module formed on a chip, and the AC LED module is formed by two inverted, opposite polarity, and parallel-connected LEDs. An AC power can be applied so that the two LEDs are lighted according to opposite polarity half-wave operation.

However, in conventional LED chip structures having AC loops, each LED chip can only emit light under a forward bias or a reverse bias condition of an AC power cycle. In other words, at each moment only half of the chip surface area is emitting light, and the LED chip of the other half of the surface area does not emit light. Therefore, a light emitting area is wasted.

### SUMMARY OF THE INVENTION

An aspect of the invention provides an LED lighting apparatus capable of enhancing a light emitting efficiency and a color rendering property.

An aspect of the invention provides an LED lighting apparatus, including a first LED unit and a rectification circuit. The rectification circuit includes a second LED unit. The first LED unit is disposed on a direct current (DC) path, configured to emit a first light. The rectification circuit is coupled to an alternating current (AC) power source and the first LED unit, the rectification circuit configured to provide a DC power signal to the DC path. A second LED unit is disposed on a first AC path and coupled between the AC power source and the DC path. The second LED unit is configured to emit a second light to mix with the first light, for generating a third light.

In an embodiment of the invention, the LED lighting apparatus further includes a third LED unit, a fourth LED unit, and a fifth LED unit. The third LED unit is disposed on the first AC path and coupled between the AC power source and the AC path. The fourth LED unit is disposed on a second AC path and coupled between the AC power source and the DC path. The fifth LED unit is disposed on the second AC path and coupled between the AC power source and the DC path.

In an embodiment of the invention, the first light is a white color light or a blue color light, and the second light is a red color light. In another embodiment of the invention, the first LED unit includes a first LED. The second LED unit includes a second LED. A reverse bias of the second LED is larger than a reverse bias of the first LED.

In an embodiment of the invention, the first LED unit includes a plurality of LEDs. The aforesaid plurality of LEDs are disposed on the DC path and coupled in parallel and/or in series. In another embodiment of the invention, the second LED unit includes a plurality of LEDs. The aforesaid plurality of LEDs are disposed on the first AC path and coupled in parallel and/or in series.

In an embodiment of the invention, the rectification circuit further includes a Zener diode or a Schottky barrier diode. The Zener diode or the Schottky barrier diode is disposed on the first AC path and coupled in series with the second LED.

In an embodiment of the invention, the LED lighting apparatus further includes a base plate, in which the rectification circuit and the first LED unit are respectively disposed on different regions of the base plate. In another embodiment of the invention, the first LED unit has a growth substrate and a plurality of LEDs disposed on the growth substrate that are electrically connected to each other, and each of the LEDs has a plurality of semiconductor layers stacked on the growth substrate.

In an embodiment of the invention, the rectification circuit further includes a Wheaston bridge formed by at least four rectifier devices, and each of the rectifier devices are respectively disposed on the base plate. In another embodiment of the invention, the rectifier device is a Schottky barrier diode, a Zener diode, a silicon semiconductor device or a group III-V compound semiconductor device.

In an embodiment of the invention, the Wheatston bridge includes the first AC path and the second AC path. The second LED unit, the first rectifier device, the first LED unit, and the third rectifier device are located on the first AC path and serially coupled in sequence. The fourth LED unit, the first LED unit, and the second rectifier device are located on the second AC path and serially coupled in sequence.

In an embodiment of the invention, the rectification circuit further includes a first conductive pattern and a second conductive pattern respectively disposed on the base plate. The first conductive pattern is configured to electrically connect a terminal of the AC power signal with the first rectifier device and the second rectifier device. The second conductive pattern is configured to electrically connect another terminal of the AC power signal with the third rectifier device and the fourth rectifier device.

In an embodiment of the invention, the rectification circuit further includes a third conductive pattern and a fourth conductive pattern respectively disposed on the base plate. The third conductive pattern is configured to electrically connect an electrode of the LED unit with the first rectifier device and the fourth rectifier device. The fourth conductive pattern is configured to electrically connect another electrode of the LED unit with the second rectifier device and the third rectifier device.

In an embodiment of the invention, a material of the growth substrate is selected from the group consisting of sapphire, SiC, Si, ZnO, GaAs, and MgAl₂O₄. In another embodiment of the invention, the base plate is made of a thermal conductive material. In another embodiment of the invention, the base plate is a circuit board, a silicon substrate, a ceramic substrate, or a metallic substrate. In another embodiment of the invention, the base plate further includes a heat spreader block, in which the LED unit is disposed on the heat spreader block, and the heat spreader block is configured to provide the LED unit a path for thermal dissipation.

In an embodiment of the invention, the first LED unit further disposing at least a phosphor material on the LEDs.

In an embodiment of the invention, a light emitted by the LEDs mixes with a light emitted by exciting the phosphor material for generating a white light.

In summary, the embodiments of the invention broadly described herein adopt the rectification circuit to provide the DC power signal to a DC path having the first LED unit. Moreover, by disposing the second LED unit on the AC path in the AC circuit, the second LED unit not only may be used as a rectifier device, but an overall light emitting efficiency may be enhanced. Furthermore, a different light than the first LED unit may be emitted to enhance a color rendering property.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an LED lighting apparatus in accordance with an embodiment of the invention.

FIG. 2 is a schematic cross-sectional view of the LED light apparatus depicted in FIG. 1.

FIG. 3 is an equivalent circuit diagram of an LED lighting apparatus in accordance with another embodiment of the invention.

FIG. 4 is an equivalent circuit diagram of an LED lighting apparatus in accordance with another embodiment of the invention.

FIG. 5 is an equivalent circuit diagram of an LED lighting apparatus in accordance with another embodiment of the invention.

FIG. 6 is an equivalent circuit diagram of an LED lighting apparatus in accordance with another embodiment of the invention.

FIG. 7 is an equivalent circuit diagram of an LED lighting apparatus in accordance with another embodiment of the invention.

### DESCRIPTION OF EMBODIMENTS

According to embodiments of the invention as broadly described herein, an LED lighting apparatus includes a rectification circuit and a direct current (DC) path. Since the LED lighting apparatus adopts the rectification circuit, the LED lighting apparatus may directly receive an AC power source and provide a DC power signal to the DC path. Therefore, an LED unit disposed on the DC path may be continuously lit, and a light emitting efficiency of the LED lighting apparatus may be enhanced.

Moreover, an LED unit may be disposed in the rectification circuit. Not only can the LED unit be used to emit light, but also as a rectifier device. Therefore, the light emitting efficiency may be further enhanced and a cost of the rectifier device can be saved.

Furthermore, when the rectification circuit and the DC path can respectively emit different colors of light, a color rendering property of the LED lighting apparatus may be enhanced. The following embodiments are broadly described with reference to the drawings.

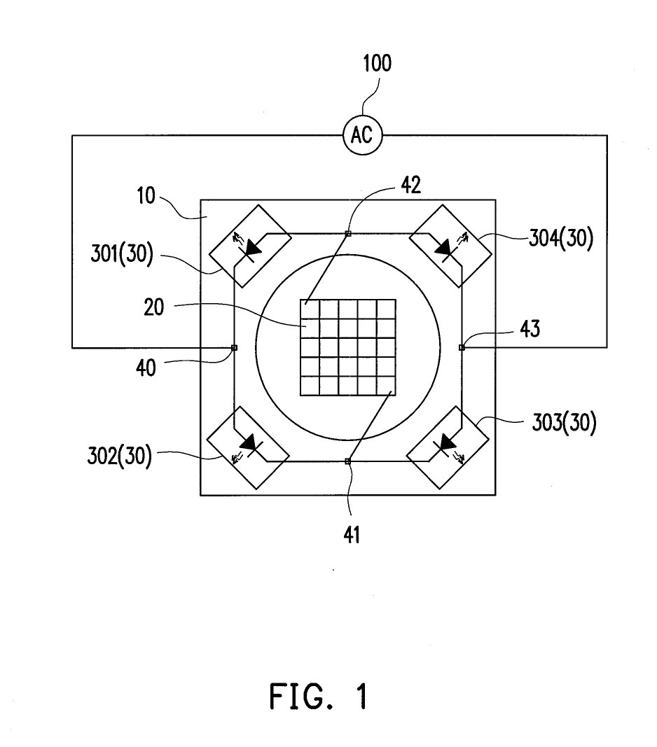

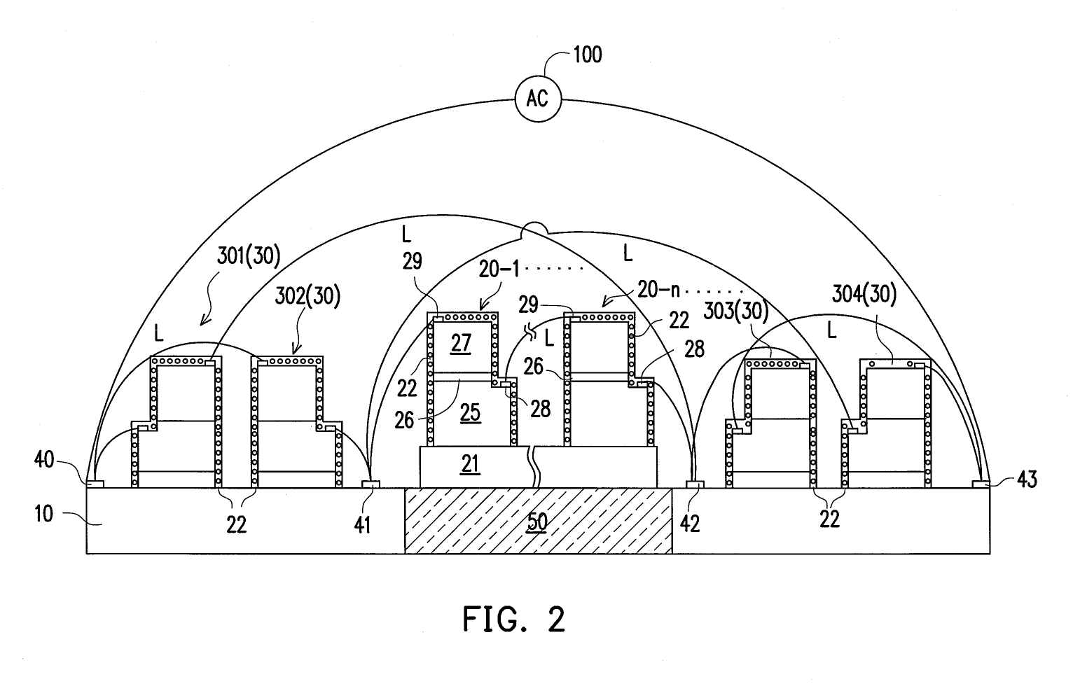

FIG. 1 is a top view of an LED lighting apparatus in accordance with an embodiment of the invention. FIG. 2 is a schematic cross-sectional view of the LED light apparatus depicted in FIG. 1. Referring to FIGS. 1 and 2 together, an LED lighting apparatus in the present embodiment includes an LED unit 20 and a rectification circuit 30. The rectification circuit 30 includes at least an LED unit. The present embodiment adopts four LED units, e.g. LED units 301-304, as an example for description. The LED units 301-304 may form a Wheatston bridge. The LED units 30 and 301-304 may respectively include a plurality of LEDs. In other embodiments of the invention, the rectification circuit 30 may also be implemented in alternate bridge circuits. The LED units 20 and 301-304 are LED array chips, for example.

The LED unit 20 is disposed on the DC path and may be configured to emit a first light, e.g. a blue color light. The LED units 301-304 are disposed on the DC path and coupled between an AC power source 100 and the DC path. The LED units 301-304 may be configured to emit a second light, e.g. a red color light. If the LED units 301-304 are disposed near the LED unit 20, then visually the second light emitted by the LED units 301-304 generate a light mixing effect with the first light emitted by the LED unit 20, and thereby generate a third light. Hence, the color rendering property of the LED lighting apparatus may be enhanced.

From another perspective, the rectification circuit 30 is coupled to the AC power source 100 and the LED unit 20, and the rectification circuit 30 is configured to provide the DC power signal to the DC path in accordance with an AC power signal provided by the AC power source 100. In the present embodiment of the invention, the AC power signal may be 90-120 V, 180-240 V, or 270-330 V. It should be understood that, not only can the LED units 301-304 emit light, but the LED units 301-304 may also be used as rectifier devices. For example, when the AC power source 100 provides a positive half-wave AC power, the positive half-wave AC power respectively flows through the LED units 303, 20, and 301 in sequence. When the AC power source 100 provides a negative half-wave AC power, the negative half-wave AC power respectively flows through the LED units 302, 20, and 304 in sequence.

In other words, during a positive half-wave AC power period, the LEDs units 303, 20, and 301 emit light. During a negative half-wave AC power period, the LEDs units 302, 20, and 304 emit light. It should be noted that, the LED units 301-304 employed as rectifier devices may also be used to emit light. Moreover, the LED unit 20 can emit light during both the positive and negative half-waves. Therefore, the light emitting efficiency of the LED lighting apparatus may be enhanced.

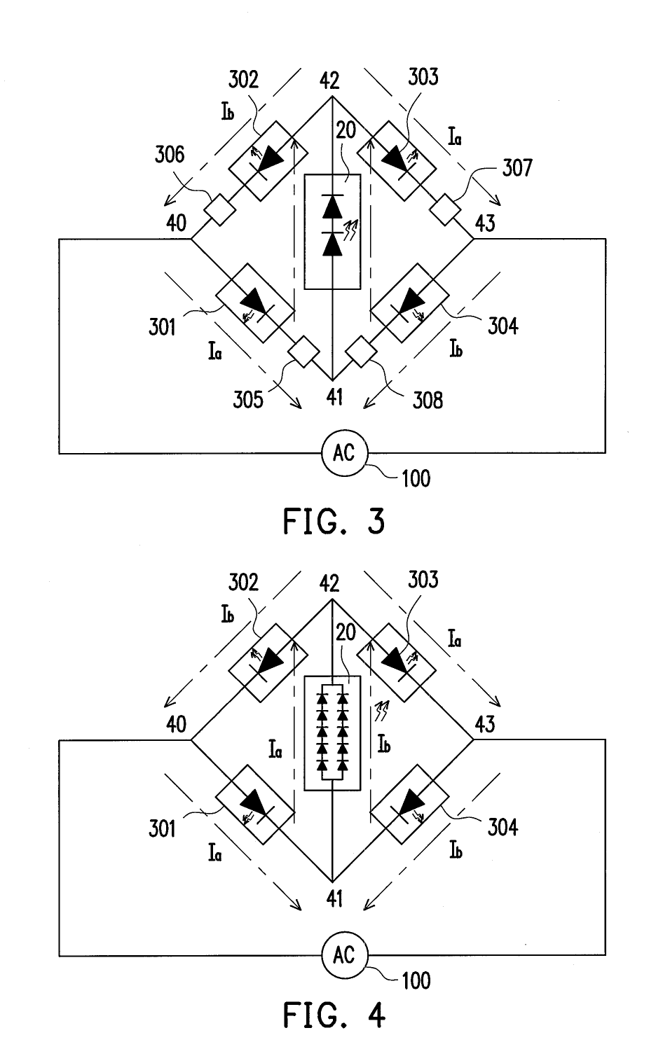

FIG. 3 is an equivalent circuit diagram of an LED lighting apparatus in accordance with another embodiment of the invention. From another perspective, the rectification circuit 30 has a first current path Iₐ and a second current path I_{b}. The first LED unit 301, the LED unit 20, and the third LED unit 303 are located in the first current path Iₐ and sequentially connected in series. Moreover, the fourth LED unit 304, the LED unit 20, and the second LED unit 302 are located in the second current path I_{b} and sequentially connected in series. Therefore, when the AC power signal is applied to the LED lighting apparatus at a time in a positive cycle, for example, a current flows through the first current path Iₐ, conducting and lighting the LED unit 20. At a next time in a negative cycle, for example, the current flows through the second current path I_{b}, conducting and lighting the LED unit 20. Therefore, when the AC power signal is provided, after the first LED unit 301, the second LED unit 302, the third LED unit 303, and the fourth LED unit 304 rectifies the AC power signal, the LEDs of the LED unit 20 are conducted and kept continuously lit, thereby enhancing an overall light emitting efficiency of the LED lighting apparatus.

In order to increase a number of LEDs in the LED unit 20, in the present embodiment of the invention, the LED units 301-304 may have a plurality of LEDs connected in series, respectively, thereby increasing a reverse bias of the LED units 301-304. Nevertheless, the invention should not be construed as limited to the above implementation.

Typically speaking, for LEDs capable of emitting different colors of light, the biased voltages thereof are also not the same. In the present embodiment of the invention, the LED lighting apparatus adopts LEDs capable of emitting at least two colors of light, hence LEDs having a higher reverse bias may be selected to implement the LED units 301-304, thereby enhancing the reverse bias of the LED units 301-304. More specifically, in the present embodiment, the reverse bias of the LEDs in the LED units 301-304 is larger than the reverse bias of the LED in the LED unit 20. Consequently, the number of LEDs in the LED unit 20 may be increased.

Moreover, in the present embodiment, the rectification circuit 30 further includes one or a plurality of rectifier devices (i.e. represented as 305-308 herein). In more specifics, the LED units 301-304 may be respectively connected to one or a plurality of rectifier devices 305-308, thereby increasing the reverse bias. The rectifier devices 305-308 are, for example, Zener diodes, Schottky barrier diodes (SBDs), silicon semiconductor devices, or group III-V compound semiconductors (not drawn). It should be understood that, a reverse breakdown voltage of the silicon semiconductor devices is 3000 V-6000 V, and a reverse breakdown voltage of group III-V compound semiconductors is 20 V-30 V. Therefore, by adopting silicon semiconductor devices, the LED lighting apparatus may be able to withstand a higher reverse bias surge, and thus have an enhanced reliability.

In addition, the LED lighting apparatus may also include a base plate 10. In the present embodiment of the invention, the rectification circuit 30 and the LED unit 20 may be disposed on the base plate 10, and the rectification circuit 30 and the LED unit 20 are electrically connected to each other via a conductive line L. However, the invention should not be construed as limited to the above implementation. In other embodiments, the LED unit 20 and the rectification circuit 30 may be disposed on different base plates.

In the present embodiment, although the LED unit 20 and the rectification circuit 30 are packaged together, this implementation represents only an optional embodiment. In other embodiments, the LED unit 20 and the rectification circuit 30 may be respectively packaged independently.

In the present embodiment, the base plate 10 is a circuit board, a silicon substrate, or a ceramic substrate, configured to carry the LED unit 20 and the rectification circuit 30. A material of the ceramic substrate is, for example, Al₂O₃. In other embodiments of the invention, a heat spreader block 50 is disposed in the base plate 10, and the LED unit 20 is disposed on the heat spreader block 50. Therefore, when the LED unit 20 generates heat during operation, the heat spreader block 50 may rapidly remove heat outside of the LED lighting apparatus. Thus, the reliability of the LED lighting apparatus is enhanced. Likewise, in other embodiments of the invention, a heat spreader block may be disposed under the LED units 301-304. Moreover, in other embodiments, the base plate may be made of a thermal conductive material, e.g. a metallic substrate, in which the thermal conductive material provides the LED unit 20 and the rectification circuit 30 a preferable path for thermal dissipation.

Furthermore, the LED unit 20 may include a growth substrate 21, as well as the first LEDs 20-1 to the nth LEDs 20-n connected in series together and disposed on the growth substrate 21. The LEDs may be blue LEDs or ultraviolet (UV) LEDs. A wavelength range of the blue LEDs is 430 nm-480 nm, for example, and a wavelength range of the UV LEDs is 360 nm-415 nm, for example. Each of the LEDs include an n-type semiconductor layer 25, an active layer 26, and a p-type semiconductor layer 27 stacked in sequence on the growth substrate 21. In the present embodiment of the invention, a material of the growth substrate 21 may be but not limited to sapphire, SiC, Si, ZnO, GaAs, and MgAl₂O₄, etc. A material of the n-type semiconductor layer 25, the active layer 26, and the p-type semiconductor layer 27 may be two-element, three-element, or four-element compound semiconductor materials, including but not limited to GaN, AlGaN, InGaN, or AlInGaN, etc. In other embodiments of the invention, then n-type semiconductor layer 25, the active layer 26, and the p-type semiconductor layer 27 may be made of other materials. It should be understood that, according to embodiments of the invention broadly described herein, an LED structure of the LED lighting apparatus adopts the growth substrate 21 as the substrate, and employs an epitaxial process to form a stacking structure of the n-type semiconductor layer 25, the active layer 26, and the p-type semiconductor layer 27 on the growth substrate 21. However, fabrication of the semiconductor layers in the LED in embodiments of the invention is not limited to the epitaxial process. A semiconductor deposition process known to persons of ordinary skill in the art is within the scope of the invention. Clearly, the LEDs in the present embodiment may also include a homogeneous or a heterogeneous structure. Moreover, each of the LEDs in the LED lighting apparatus in embodiments of the invention has a first bonding pad 28 and a second bonding pad 29 respectively formed on the n-type semiconductor layer 25 and the p-type semiconductor layer 27. The first bonding pad 20 of the first LED 20-1 is electrically connected with a second bonding pad 29 of a neighboring LED via a conductive line L, and similarly, the first bonding pad 20 of an n−1 LED is electrically connected with the second bonding pad 29 of an nth LED 20-n via the conductive line L.

In addition, according to embodiments of the invention, the LED unit 20 of the LED lighting apparatus includes at least a phosphor material layer 22 formed on each of the LEDs. A fabrication process of the phosphor material layer 22 is, for example, a gaseous coating process, an ultrasonic vibration process, or an adhesion process. If the gaseous coating process is employed, then phosphor material layers 22 having conformal widths are formed on a surface of each of the LEDs in the LED unit 20. Moreover, at least a phosphor material is filled in the phosphor material layer 22, and after being excited by the LED unit 20, the phosphor material converts the emitted light of the LED unit 20 into a visible light of a different wavelength, e.g., a visible yellow, red, or green light. The phosphor material of the phosphor material layer 22 may be doped cerium yttrium aluminum garnet, e.g., TAG:CE or YAG:CE; or a phosphor with a silicate substrate, e.g., (SrBa)SiO₄:Eu²⁺, (SrBa)Si(OCl)₄:Eu²⁺, or (SrBa)SiO₄₋ₓClₓ:Eu²⁺; or an oxidized phosphor, e.g., (SrBaCa)Si₂O₂N₂ or (SrBaCa)Si₂(OCl)₂N₂.

In the LED lighting apparatus according to embodiments of the invention, a light source emitted by the LEDs in the LED unit 20 is mixed with a light source converted by the excited phosphor material of the phosphor material layer 22, so that a white lighting apparatus is achieved. For example, when the LEDs emit blue light, the phosphor material is a yellow phosphor. Alternatively, when the LEDs emit blue light, the phosphor material is a red phosphor added with a green phosphor. When the LEDs emit UV light, the phosphor material is the yellow phosphor added with the blue phosphor, or the red phosphor added with the green phosphor, and further added with the blue phosphor. Furthermore, a selection of two or more phosphors in combination may be determined by considering properties such as light emitting efficiency or color rendering index.

In light of the foregoing, after completing the fabrication of the LED unit 20, a soldering process or an adhesive process is employed to fix the LED unit 20 to the base plate 10. The rectification circuit 30 is likewise disposed on the base plate 10, although located at a different region than the LED unit 20. Specifically, by employing the soldering process or the adhesive process, the rectification circuit 30 is fixed to the base plate 10 and separated a distance from the LED unit 20. Therefore, when the rectification circuit 30 or the LED unit 20 is damaged, only the damaged device in the apparatus needs to be interchanged, thereby simplifying a replacement process. Similarly, persons having ordinary knowledge in the art may easily implement the LED units 301-304, hence the detailed descriptions thereof are not repeated here.

In addition, the LED lighting apparatus further includes a first conductive pattern 40 and a fourth conductive pattern 43, respectively disposed on the base plate 10. Moreover, the first conductive pattern 40 is electrically connected with the first LED unit 301 and the second LED unit 302 via the conductive line L. The AC power signal is inputted in the first LED unit 301 by the first conductive pattern 40, flowing past the LED unit 20 and the third LED unit 303. The fourth conductive pattern 43 is electrically connected with the third LED unit 303 and the fourth LED unit 304 via the conductive line L. The AC power signal is inputted in the fourth LED unit 304 by the fourth conductive pattern 43, flowing past the LED unit 20 and the second LED unit 302.

Moreover, the rectification circuit 30 according to the embodiments of the invention further includes a second conductive pattern 41 and a third conductive pattern 42, respectively disposed on the base plate 10. The second conductive pattern 41 is electrically connected with an electrode of the LED unit 20, the first LED unit 301, and the fourth LED unit 304 via the conductive line L. The third conductive pattern 42 is electrically connected with another electrode of the LED unit 20, the second LED unit 302, and the third LED unit 303 via the conductive line L.

FIG. 4 is an equivalent circuit diagram of an LED lighting apparatus in accordance with another embodiment of the invention. Referring to FIG. 4, the present embodiment and the foregoing embodiments differ in that, the LEDs in the LED unit 20 are not limited to being serially coupled in a single column. The LEDs in the LED unit 20 depicted in FIG. 4 are serially arrayed in dual columns and also parallel connected. Consequently, the LEDs used in the LED lighting apparatus according to embodiments of the invention may be monochromatic or polychromatic, therefore the number of LEDs having the same wavelength may be increased, or a light mixing effect may be achieved by having LEDs of different wavelengths.

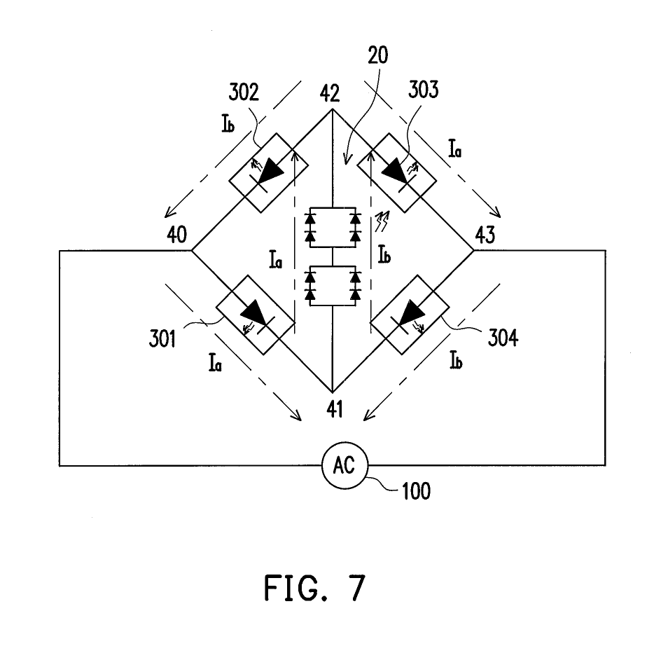

Clearly, the LEDs in the LED unit 20 are not limited to being serially coupled in a single column, or serially arrayed in dual columns and parallel connected. As shown in FIGS. 6 and 7, the LEDs may be arranged to be serially coupled and parallel connected with each other.

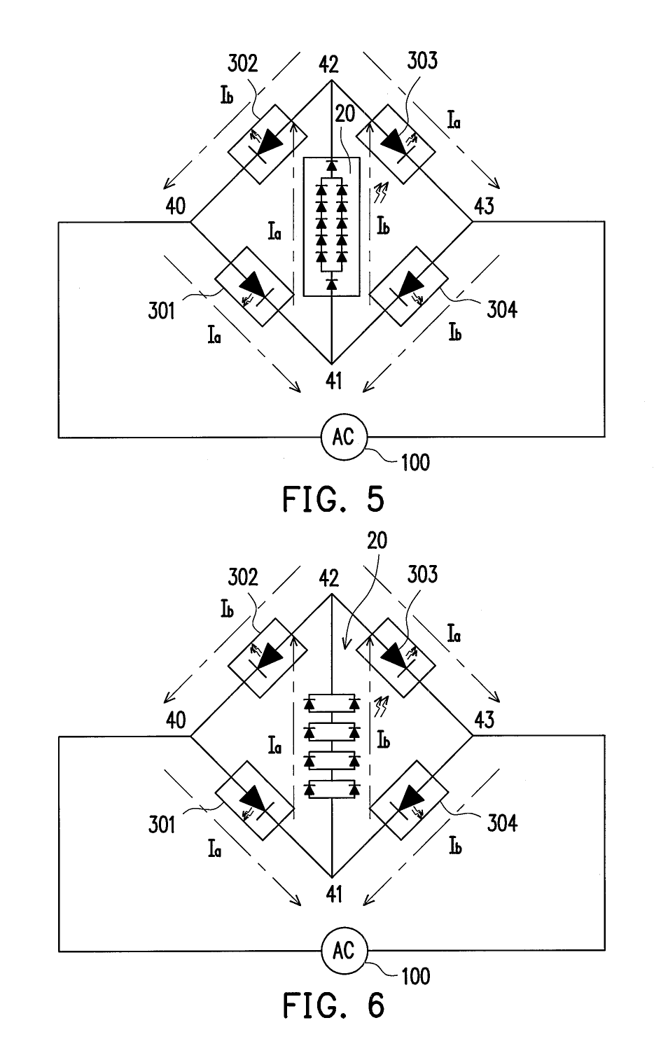

FIG. 5 is an equivalent circuit diagram of an LED lighting apparatus in accordance with another embodiment of the invention. The LED unit 20 includes at least a first group and a plurality of parallel connected second groups. The first group and the second groups are connected in series with each other, and the first group has two serially coupled LEDs respectively located above and below the second groups. Each of the second groups has a plurality of serially coupled LEDs.

FIG. 6 is an equivalent circuit diagram of an LED lighting apparatus in accordance with another embodiment of the invention. The LED unit 20 includes a plurality of serially coupled groups, and each of the groups has two parallel connected LEDs. FIG. 7 is an equivalent circuit diagram of an LED lighting apparatus in accordance with another embodiment of the invention. The LED unit 20 includes a plurality of serially coupled first groups, and each of the first groups has a plurality of parallel connected second groups. Moreover, each of the second groups has a plurality of serially coupled LEDs. Similarly, persons having ordinary knowledge in the art may easily implement the LED units 301-304, hence the detailed descriptions thereof are not repeated here.

A majority of LEDs in the LED units are serially coupled in single columns, as shown in FIG. 3; or serially arrayed in dual columns and parallel connected, as shown in FIG. 4; or connected both in series and in parallel, as shown in FIGS. 6 and 7. Therefore, a voltage and a current received by each of the LED units are substantially fixed. Consequently, an expected life time of each of the LEDs is substantially the same.

In light of the foregoing, according to embodiments of the invention broadly described herein, the LED lighting apparatus includes the rectification circuit and the first LED unit disposed on the DC path. The LED unit disposed on the rectification circuit not only may be used as a rectifier device, the LED unit may also enhance the overall light emitting efficiency. Moreover, the light emitted by the second LED unit may be mixed with the light emitted by the first LED unit, thereby enhancing the color rendering property of the LED lighting apparatus.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A light-emitting diode (LED) lighting apparatus, comprising:
a first LED unit disposed on a direct current (DC) path, configured to emit a first light; and
a rectification circuit coupled to an alternating current (AC) power source, configured to provide a DC power signal to the DC path, the rectification circuit comprising:
a second LED unit disposed on a first AC path and coupled between the AC power source and the DC path, configured to emit a second light to mix with the first light for generating a third light.

2. The LED lighting apparatus as claimed in claim 1, further comprising:
a third LED unit disposed on the first AC path and coupled between the AC power source and the DC path;
a fourth LED unit disposed on a second AC path and coupled between the AC power source and the DC path; and
a fifth LED unit disposed on the second AC path and coupled between the AC power source and the DC path.

3. The LED lighting apparatus as claimed in claim 1, wherein the first light is a white light or a blue light, and the second light is a red light.

4. The LED lighting apparatus as claimed in claim 1, wherein the first LED unit comprises a first LED, the second LED unit comprises a second LED, and a reverse bias of the second LED is larger than a reverse bias of the first LED.

5. The LED lighting apparatus as claimed in claim 1, wherein the first LED unit comprises:
a plurality of LEDs disposed on the DC path and coupled in parallel and/or in series.

6. The LED lighting apparatus as claimed in claim 1, wherein the second LED unit comprises:
a plurality of LEDs disposed on the first AC path and coupled in parallel and/or in series.

7. The LED lighting apparatus as claimed in claim 1, wherein the rectification circuit further comprises:
a Zener diode disposed on the first AC path and coupled in series with the second LED.

8. The LED lighting apparatus as claimed in claim 1, wherein the rectification circuit further comprises:
a Schottky barrier diode disposed on the first AC path and coupled in series with the second LED.

9. The LED lighting apparatus as claimed in claim 1, further comprising a base plate, wherein the rectification circuit and the first LED unit are respectively disposed on different regions of the base plate.

10. The LED lighting apparatus as claimed in claim 9, wherein the first LED unit has a growth substrate and a plurality of LEDs disposed on the growth substrate that are electrically connected to each other, and each of the LEDs has a plurality of semiconductor layers stacked on the growth substrate.

11. The LED lighting apparatus as claimed in claim 1, wherein the rectification circuit further comprises a Wheatston bridge formed by at least four rectifier devices, and each of the rectifier devices are respectively disposed on a base plate.

12. The LED lighting apparatus as claimed in claim 11, wherein the rectifier devices comprise Schottky barrier diodes, Zener diodes, silicon semiconductor devices or group III-V compound semiconductor devices.

13. The LED lighting apparatus as claimed in claim 11, wherein the Wheaston bridge comprises the first AC path and a second AC path, and the second LED unit, a first rectifier device, the first LED unit, and a third rectifier device are located on the first AC path and serially coupled in sequence, and a fourth rectifier device, the first LED unit, the second rectifier device are located on the second AC path and serially coupled in sequence.

14. The LED lighting apparatus as claimed in claim 13, wherein the rectifier circuit further comprises a first conductive pattern and a second conductive pattern respectively disposed on the base plate, the first conductive pattern configured to electrically connect a terminal of the AC power signal with the first rectifier device and the second rectifier device, and the second conductive pattern is configured to electrically connect another terminal of the AC power signal with the third rectifier device and the fourth rectifier device.

15. The LED lighting apparatus as claimed in claim 13, wherein the rectifier circuit further comprises a third conductive pattern and a fourth conductive pattern respectively disposed on the base plate, the third conductive pattern configured to electrically connect an electrode of the LED unit with the first rectifier device and the fourth rectifier device, and the fourth conductive pattern is configured to electrically connect another electrode of the LED unit with the second rectifier device and the third rectifier device.

16. The LED lighting apparatus as claimed in claim 10, wherein a material of the growth substrate is selected from the group consisting of sapphire, SiC, Si, ZnO, GaAs, and MgAl₂O₄.

17. The LED lighting apparatus as claimed in claim 10, wherein the base plate comprises a thermal conductive material.

18. The LED lighting apparatus as claimed in claim 10, wherein the base plate is a circuit board, a silicon substrate, a ceramic substrate, or a metallic substrate.

19. The LED lighting apparatus as claimed in claim 10, wherein the base plate further comprises a heat spreader block, the LED unit disposed thereon, the heat spreader block configured to provide the LED unit a path for thermal dissipation.

20. The LED lighting apparatus as claimed in claim 10, wherein the first LED unit further comprises disposing at least a phosphor material on the LEDs.
